(19) United States
(12) Patent Application Publication
(10) Pub. No.: US 2003/0102752 A1
(43) Pub. Date: Jun. 5, 2003

(54) Self-sufficient electric power system for a building

(76) Inventor: Paul M. Mathisen, Tampa, FL (US)

Correspondence Address: Stephan A. Pendorf, Pendorf & Cutliff, P.O. Box 20445, Tampa, FL, 33622-0445, US

(21) Appl. No.: 10/280,811

(22) Filed: Oct. 25, 2002

Related U.S. Application Data
(60) Provisional application No. 60/335,748, filed on Oct. 25, 2001.

(51) Int. Cl. H02K 47/04

(52) U.S. Cl. 310/113

(57) ABSTRACT

A self-sufficient system to provide electrical power to a building, the system comprising a bank of rechargeable batteries; an electric motor, the motor being energized by the batteries; a generator, the generator adapted to be run by the electric motor; gearing means connected between the electrical motor and the generator, the gearing means adapted to induce a rotation of the generator; and means for connecting the system to a power grid.

### REFERENCE TO RELATED APPLICATIONS

This application is a non-provisional of Provisional Application No. 60/335,748 filed Oct. 25, 2001.

### BACKGROUND OF THE INVENTION

1. Field of the Invention

The present invention concerns a self-sufficient system for providing all of the requirements for a building regarding electrical power.

2. Discussion of the Related Art

As time passes, energy consumption has continued to increase throughout the world as a result of the population explosion, accelerated industrialization, economic growth, and social development.

Conventionally, large generators in electric power plants have produced electrical energy requirements for residential and commercial use. These generators are commonly driven by fossil fuel (oil, natural gas, and coal) and nuclear energy sources.

Power plants utilizing nuclear fuels produce radioactive wastes, and the storage of these wastes is highly controversial.

A problem presented by the distribution and delivery of electrical power from power plants is that the electrical power must be transmitted from the power plant over long distances utilizing extremely expensive, high voltage technology. The cost of delivering electricity is a strong function of demand and varies substantially during the course of the day and season.

Further, considered from the standpoint of the installation in the individual home or from the standpoint of a total community or power service region, the electrical power systems from the power plants have been characterized by problems or shortcomings in one or another of the areas of fuel economy, peak power loads, general efficiency, and maximum flexibility or adaptability to the individual energy needs of a given building and to cyclical, seasonal, or other changes in such needs.

It would be much more efficient to convert such combustion to electrical energy at the locality or installation wherein electrical energy is to be utilized.

A most readily available source of energy, and one which has been utilized in a very limited way for satisfying certain residential energy requirements of a single-family residence, is solar radiation. The prior art approaches to satisfying certain residential energy needs by utilizing solar radiation as a primary energy source are less than optimum from reliability and economic viewpoints. Extensive backup systems are required for those times when solar radiation is unavailable or insufficient, such as during periods of cloudy weather.

Presently, homeowners and small businesses purchase and install standby generators to provide power only during periods when power from the electric grid is not available. These devices typically work through an automatic transfer switch, which activates the generator upon loss of grid power, and transfers selected “critical loads” from the grid bus to the power feed from the generator. Critical loads typically include food storage (refrigerator and freezer), furnace, sump pump, well pump (for those having water wells), and at least one lighting circuit which in a growing number of cases can amount to a home office.

The degree of sophistication of energy supplying systems for totally providing electrical power requirements of a residential or other building in lieu of that otherwise provided by an AC utility service is evidenced by U.S. Pat. No. 3,678,284 entitled “Energy Supply Apparatus and Method for a Building” to Peters. The reference describes a system for supplying electrical and thermal energy to a building. This system is arranged in association with electrical power from a conventional external source whereby, under certain conditions, an electrical generator of the system is adapted to be utilized to supply the entire electrical power requirements of certain loads in the building.

A problem presented by the electrical generating apparatus of the prior art is that typically it has not been capable of providing alternating current in precise phase synchronism with the electric power supplied by utility services except where engine speed is extraordinarily tightly regulated. Yet, even in the case of operation at precisely regulated speeds, engine and generator arrangements of the prior art have not been capable of operation in such a way that best fuel efficiency can be achieved over a highly variable load demand.

The present inventor felt a need for a simplified, economical, reliable, non-air-polluting, self-sufficient, and easy-to-use on-site apparatus for producing electrical power to a building.

### SUMMARY OF THE INVENTION

Therefore, the main object of the present invention is to provide an on-site apparatus that furnishes a building with all its required electrical energy for illumination and running electrical appliances.

It is yet another object of the present invention to provide an on-site apparatus which improves upon and overcomes the disadvantages of the prior art.

It is yet another object of the present invention to provide an on-site apparatus which does not discharge polluting effluents into the atmosphere.

It is yet another object of the present invention to provide a complete system which is simple in design, inexpensive to manufacture, rugged in construction, easy to use, and efficient in operation.

It is yet another object of the present invention to provide an on-site apparatus which is self-sufficient in producing its own power without the necessity of being connected to any outside power supply such as through wires from a power grid.

In view of the foregoing disadvantages inherent in the known apparatus for providing electricity to a building, the present inventor discovered an on-site apparatus, which furnishes a building with all its required electrical energy including illumination and running electrical appliances.

The present invention includes applying science to economic advantage, and at the same time, producing extra money to the owner of the system. For example, Florida Statutes: 366.051 established that “electricity produced by co-generation and small power production is of benefit to the public when included as part of the total energy supply of the entire grid of the state or consumed by a co-generator or small power producer. The electric utility in whose service area a co-generator or small power producer is located shall produce, in accordance with applicable law, all electricity offered for sale by such co-generator or small power producer; or the co-generator or small power producer may sell such electricity to any other electric utility in the state.”

Before explaining in detail the present invention, it is to be understood that the invention is not limited to the details of construction and the arrangement of the parts illustrated on the accompanying drawings since the invention is capable of other embodiments. Also, it is to be understood that the phraseology or terminology herein is for the purpose of description and not limitation.

The electrical power is normally provided to a household or similar relatively small load by a conventional AC utility service, i.e., commercial power source, by a pre-existing power distribution network such as the wiring which normally connects the utility to household loads, such as for lighting, heating, operation of appliances, etc. The present invention is, therefore, not primarily concerned with providing auxiliary power in the event of failure of a utility service and is not fundamentally intended to serve as a so-called standby power source which typifies the purpose of prior art household electrical power generating systems.

Broadly, these and other objects of the present invention have been accomplished by a self-sufficient system that provides electrical power to a building, the system in its most basic embodiment comprising:

a) a bank of rechargeable batteries;

b) an electric motor, the motor being energized by the batteries;

c) a generator, the generator adapted to be run by the electric motor;

d) gearing means connected between the electrical motor and the generator, the gearing means adapted to induce a rotation of the generator;

e) means for connecting the bank of batteries to an electrical outlet in the building; and

f) means for connecting the system to an electric power meter in the building.

In a first preferred embodiment, the present invention further comprises an absorbing coupler interconnected between the motor and gearing means to cushion the noises of vibration effected from the motor operations.

In a second preferred embodiment, the present invention further comprises a battery recharger, the battery recharger adapted to recharge the battery while electrical power is being received from the generator.

In a third preferred embodiment, the present invention further comprises a bank of auxiliary batteries.

In a fourth preferred embodiment, the present invention further comprises a mobile platform, wherein the system is mounted on the mobile platform.

In a fifth preferred embodiment, the present invention further comprises a switching device, the switching device adapted to isolate the power grid from the system.

The present invention also includes a method of producing self-sufficient power system to be use for powering a building comprising the steps of:

a) providing a bank of rechargeable batteries;

b) connecting the batteries to an electric motor;

c) connecting the electric motor to a generator;

d) connecting the batteries to an electrical outlet in the building; and

e) connecting the generator to an electric power meter in the building,

f) disconnecting the building from a power company; and

g) starting the generator, wherein when the generator is started, the generator powers the building;

h) wherein the outlet on the building recharges the battery bank without necessity of additional power.

The outlet in the house is plugged into the rechargeable battery bank to keep the battery storage charged without necessity of additional power.

The system requires an auxiliary set of batteries so that when the main battery is charged and running, the motor on the auxiliary set of batteries is being charged.

The system also requires a switch to switch from one set of batteries to the other set of batteries. In the case of both sets of batteries losing their charge, it will be necessary to recharge the batteries by connecting the system to the power grid.

The present invention presents the possibility of having an auxiliary electric motor and an auxiliary generator in order to avoid overheating of the system.

The present invention also includes the possibility of adding a cooling system to prevent the overheating of the system.

A more complete understanding of the improvements in energy systems in accordance with the integrated energy system of the present invention, as well as recognition of additional objects and advantages thereof, will become apparent from consideration of the following detailed description of an exemplary embodiment thereof.

### BRIEF DESCRIPTION OF THE DRAWINGS

Other objects, and many of the attendant advantages of this invention, will be readily appreciated as the same becomes better understood by reference to the following detailed description when considered in connection with the accompanying drawings wherein:

FIG. 1 is a schematic view of the basic embodiment of the present invention.

FIG. 2 is a schematic view of a first preferred embodiment of the present invention.

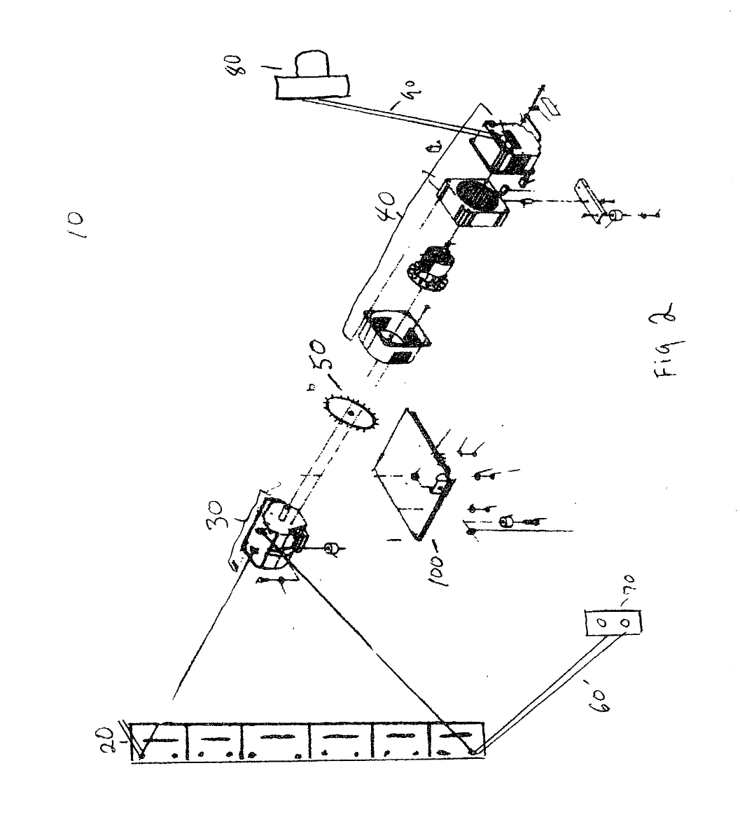

### DETAILED DESCRIPTION

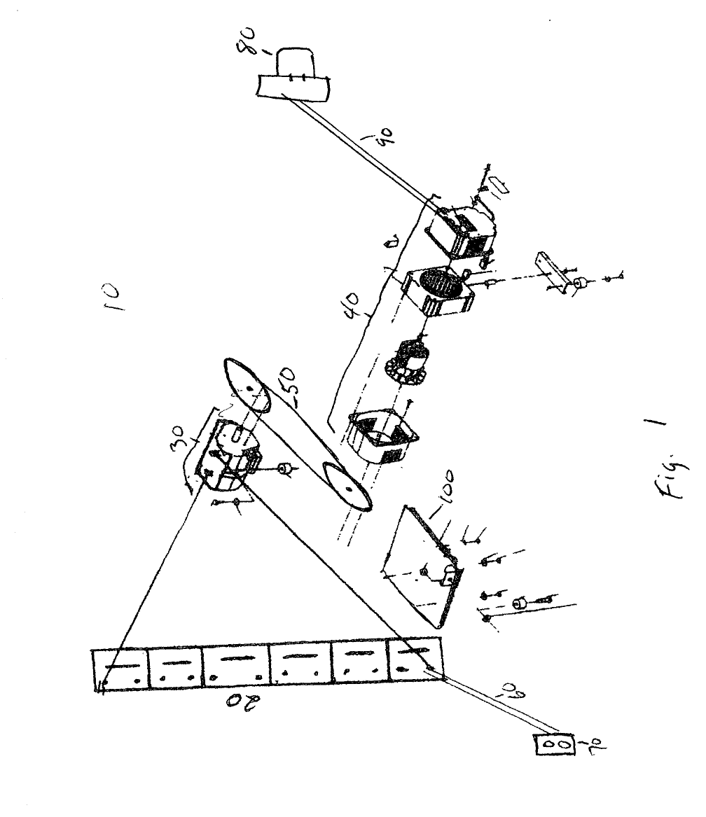

In essence, and with reference to FIG. 1, the self-sufficient system to provide power supply to a building of the present invention is designated generally by the numeral 10 and comprises a bank of rechargeable batteries 20, an electric motor 30, a generator 40, the generator adapted to be run by the electric motor; gearing means 50 connected between the electrical motor and the generator, the gearing means adapted to induce a rotation of the generator; means 60 for connecting the system to a house electrical outlet 70, means 90 for connecting the system to an electric power meter 80 in the building.

Batteries

The battery power supply unit of the system for supplying electricity to the house is a combined battery unit, namely banks of main and auxiliary rechargeable batteries 20, which are provided for alternately furnishing electrical energy to the electrical motor 30. Each bank of batteries includes a plurality of batteries connected in series, and mounted to provide a predetermined voltage for the electrical motor.

In the electric power unit for supplying electric power to the electric motor, the “main bank of batteries” means a whole set of batteries forming the power source. An “auxiliary bank of batteries” to be described afterward is a battery for supplementing the battery power supply unit for a voltage drop.

This invention optionally includes the use of solar, air-operated instrumentalities, a fuel cell of hydrogen and oxygen, an alternator for recharging the batteries in case of an emergency. This type of system provides a pollution free system.

The present invention further comprises a supplemental charging apparatus comprising a small capacity motor that turns an associated generator for creating supplemental electrical energy for recharging of the various main or auxiliary batteries in the event that the wind charging impellor or the solar energy converter fails to provide sufficient energy for the adequate recharging of said batteries.

A meter may be provided within the circuit line so as to disclose the amount of amperage being drawn by the motor during its operations.

A switching relay functions as a control source for determining which bank of batteries energizes the engine, and which other bank of batteries is being recharged at a given instance. A switch may be either manually operated, or actuated by a meter that determines when the operating bank of batteries may have a reduced charge that is not sufficient to drive the electric motor at full capacity.

Initially, the battery and the electric motor are fully charged.

Electric Motor

The electrical motor is a conventional, commercially available unit. The electrical motor is coupled via a belt to the input pulley 50. This causes the drive shaft to begin rotating, and thereby induces a rotation of the generator.

Electric Generator

The generator has a drive shaft to which is fastened a pulley 50. The pulley will drive the belts and thus drive the generator shaft to rotate the generator.

In another preferably embodiment, the generator directly gear driven by the electric motor.

The generator produces enough electrical energy so to power the house illumination and electrical appliances, as described in connection with FIG. 1.

A typical unit for a one-family house could consist of a four to twelve kilowatt output generator. The output of the generator is routed to the building electrical energy distribution system, the main junction box of an existing building, for example. The building's internal distribution system, the wires and outlets in the typical house, supplies power to various appliances, lights, and the like.

The mechanical aspects of the new electrical power generating apparatus of the present invention in FIG. 1 shows only a simplified physical arrangement of mechanical elements of the invention within an mobile enclosure. However, the system includes relatively more compact electronic circuitry, including various sensors and controls, which may also be contained within enclosure. Therefore, it should be observed that enclosure may also house certain elements of such circuitry except those which are necessarily located outside the enclosure for interconnection or use in association with pre-existing electrical wiring interconnecting an AC utility service with household or similar electric load, for which the new system is intended to provide AC power.

The generator will produce all the electrical (120VAC, 240VAC & 120VDC) power needed to maintain the system operating all the time, as well as to supply the power requirements of the building. The generator has an output of 5 to 20 kilowatts depending on the size of the building.

The system 10 also included a power grid conductor (not shown) connected between the system 10 and an electrical power grid (not shown) operated by an electricity provider such as a public utility, commercial supplier, government, private distribution network, or cooperative association.

Additionally, the system 10 further comprises a switching mechanism that connects and disconnects the system 10 from the power grid as required.

All of the components can be mounted to platform 100 such as a mobile metallic enclosure such as a trailer or case. The size of the mobile enclosure will depend on the building requirements. The mobile enclosure has a bottom wall and sidewalls, a top wall and optionally wheels. When the mobile enclosure is a trailer, it also includes a hitch (not shown) to permit towing of the trailer behind a vehicle such as a pickup truck.

The present invention optionally comprises a noise absorbing coupler to produce a cushioning of the vibrations generally generated within the housing.

From the foregoing detailed description of the disclosure, it is evident that the instant invention is novel and is a contribution of great significance to the art to the production of energy to fulfill the requirements of a building.

It will be seen that this system gives a very high overall efficiency compared to a power system run wholly from an external main supply. The increase in efficiency provides conservation of energy and savings in the overall direct costs of light, power, and heating and cooling for a building. The extra capital costs for installing the apparatus versus the costs of conventional systems are reduced to the minimum.

Appropriate standard sizes can be developed for buildings ranging from commercial and industrial to single-family residential.

What I claim is:

1. A self-sufficient system to provide electrical power to a building without using a power grid, the system comprising:
a) a bank of rechargeable batteries;
b) an electric motor, the motor being energized by the batteries;
c) a generator, the generator adapted to be run by the electric motor;
d) gearing means connected between the electrical motor and the generator, the gearing means adapted to induce a rotation of the generator;
e) means for connecting the bank of batteries to an electrical outlet in the building; and
f) means for connecting the system to an electric power meter in the building,
wherein the system produces all the electrical power needed by the building.

2. A self-sufficient system according to claim 1, further comprising an absorbing coupler interconnected between the motor and gearing means to cushion the noises of vibration effected from the motor operations.

3. A self-sufficient system according to claim 1, further comprising a battery recharger component, the battery recharger adapted to recharge the battery while electrical power is being received from the generator.

4. A self-sufficient system according to claim 1, further including a bank of auxiliary batteries.

5. A self-sufficient system according to claim 1, further comprising a mobile platform, wherein the system is mounted on the mobile platform.

6. A self-sufficient system according to claim 1, further comprising a switching device, the switching device adapted to isolates the power grid from the system.

7. A self-sufficient system according to claim 1, further comprising a meter to show the amount of amperage being drawn by the motor during its operations.

8. A self-sufficient system according to claim 1, further comprising a switching relay to control the selection of the bank of batteries.

9. A self-sufficient system according to claim 8, wherein the switch is manually operated.

10. A self-sufficient system according to claim 8, wherein the switch is actuated by a meter that determines when the operating bank of batteries may have a reduced charge that is not sufficient to drive the electric motor at full capacity.

11. The self-sufficient system according to claim 1, wherein an output of the generator is routed to a building electrical energy distribution system.

12. The self-sufficient system according to claim 11, wherein the building electrical energy distribution system supplies power to a device selected from the group consisting of appliances, lights, and heater.

13. The self-sufficient system according to claim 1, further comprising electronic circuitry including various sensors and controls to manage the system.

14. The self-sufficient system according to claim 1, further comprising a power grid conductor connected between the system and the electrical power grid operated by an electricity provider selected from the group consisting of a public utility, a commercial supplier, a government or private distribution network, and a cooperative association.

15. A method of producing self-sufficient power system to be used for powering a building, the method comprising the steps of:
a) providing a bank of rechargeable batteries;
b) connecting the batteries to an electric motor;
c) connecting the electric motor to a generator;
d) connecting the batteries to an electrical outlet in the building; and
e) connecting the generator to an electric power meter in the building,
f) disconnecting an electricity of a power company; and
g) starting the generator, wherein when the generator is started, the generator powers the building;
wherein the outlet on the building recharges the battery bank without necessity of additional power.

16. A self-sufficient system according to claim 1, wherein in case of an emergency, the battery bank is recharged by a source selected from the group consisting of solar panel, air operated instrumentalities, a fuel cell, and an alternator.

17. A self-sufficient system according to claim 1, wherein the gear means is a pulley.

18. A self-sufficient system according to claim 1, wherein the gear means is a direct gear drive.

19. A self-sufficient system according to claim 1, wherein the generator is an electric generator.
